(19) United States
(12) Patent Application Publication
(10) Pub. No.: US 2025/0387943 A1
(43) Pub. Date: Dec. 25, 2025

(54) METHOD FOR PRODUCING AN OPTIMISED INSULATING PANEL, INSULATING PANEL AND INSULATING STRUCTURE COMPRISING SUCH A PANEL

(71) Applicant: CIBB (CONSTRUCTION INNOVATION BOIS BETON), HAGUENAU (FR)

(72) Inventors: Serge FAUVRE, HAGUENAU (FR); Pierre FEHR, HAGUENAU (FR); Rémy GRUNNAGEL, OBERLAUTERBACH (FR); Charles HERRMANN, WOELLENHEIM (FR)

(21) Appl. No.: 18/881,464

(22) PCT Filed: Jul. 12, 2023
(86) PCT No.: PCT/EP2023/069357

§ 371 Date: Jan. 6, 2025

(30) Foreign Application Priority Data
Jul. 13, 2022 (FR) FR2207254

(51) Int. Cl. B27N 3/04; B27N 3/00; B27N 9/00

(52) U.S. Cl. CPC B27N 3/04; B27N 3/002; B27N 9/00

(57) ABSTRACT

The invention relates to a method for manufacturing an insulating board based on cereal straw, characterised in that it comprises the steps of:
a) mechanically grinding and screening the straw to obtain a defibrated straw, the strands of which have an average length of between 3 mm and 11 mm and an average diameter of between 0.5 mm and 2.5 mm,
b) using a mixer and mixing the defibrated straw with a binder material in a proportion by weight of between 3% and 25%, preferably between 4% and 10%,
c) injecting compressed air into the mixture to homogenise said mixture,
d) heating the insulating board and calibrating it lengthwise and widthwise,
e) calibrating the thickness of the material forming the insulating board,
f) heating the insulating board to a temperature of at least 90° C., preferably between 110° C. and 150° C., across the entire thickness of said insulating board and for a period of at least 3 minutes,
g) cooling the insulating board to ambient temperature, and
h) packaging the insulating board.

### TECHNICAL FIELD

The present invention relates to the general technical field of insulating materials used in construction. These insulating materials are generally intended to cover a wall or roof to provide heat and sound insulation. These insulating materials, for example in the form of rigid or semi-rigid insulating boards, can also be integrated in prefabricated modular structures made of wood or concrete.

These insulating materials also have to comply with national and/or European standards and have a fire classification.

The specifications of public and private calls for tender, both in France and in other countries, are increasingly calling for the use of bio-based insulating materials with the smallest possible environmental footprint. These insulating materials are made, for example, using renewable and recyclable raw materials, such as wood fibres, cellulose wadding, textile fibres, expanded cork, hemp, sheep's wool or other bio-based materials.

The term “bio-based materials” means materials derived from renewable organic matter (biomass) of plant or animal origin.

The invention relates more particularly to the manufacture of such insulating materials in the form of insulating boards.

### PRIOR ART

By way of example, it is known either to use cereal straw to insulate a wall or to make such a wall using bales of straw. These bales then have to be combined with siding-like elements to achieve the performance in terms of fire resistance and impermeability to water and air as stipulated by law. These sub-assemblies generally have wall thicknesses greater than those obtained when using non-bio-based insulating materials, in order to compensate for their very average or poor thermal conductivity value (lambda, λ).

It should also be noted that, due to their limited fire performance, most known bio-based insulating materials are not suitable or authorised for buildings with more than three floors.

The current use of straw as an insulating material has numerous drawbacks. These include the limitation to buildings with a maximum of three floors, the size of the bales of straw, the significant generation of dust and debris, the increase in the weight of the structure owing to the thickness of the insulating material, the need to add non-bio-based material such as a gypsum plate or rock wool, the fact that it is not available as a mass-produced product manufactured on an industrial scale.

A method for manufacturing a board based on rice straw mixed with a binder material of the phenolic resin type is known from document WO 2018/018079 A1.The method involves obtaining a moisture level in the rice straw of less than 12%, then forming the board by heating the mixture to a high temperature of more than 150° C. and up to 250° C., and compressing the mixture by applying high pressure thereto. Such operating parameters are very complicated to implement and have a negative impact on the energy costs and profitability of that manufacturing method. The described method requires the use of a stationary press to obtain the desired high pressure and high temperatures. This makes continuous production impossible.

### DISCLOSURE OF THE INVENTION

An object of the invention is therefore to overcome the disadvantages of the prior art by proposing a novel method for manufacturing insulating boards from an environmentally friendly raw material that is renewable, recyclable and available in virtually all rural areas.

Another object of the invention is to propose a method for manufacturing insulating boards which is simple to carry out and cost-effective.

Another object of the invention is to provide insulating boards having excellent fire performance and heat and sound insulation performance.

Another object of the invention is to provide insulating boards having sufficient properties and performance to allow them to be used in buildings with more than three floors.

Another object of the invention is to provide prefabricated modular insulation elements having excellent fire performance and heat and sound insulation performance.

The objects of the invention are achieved by means of a method for continuously manufacturing an insulating board based on cereal straw, characterised in that it comprises the steps of:
a) mechanically grinding the straw to obtain a defibrated straw, the strands of which have an average length of between 3 mm and 22 mm, preferably between 3 mm and 11 mm, and an average diameter of between 0.5 mm and 4.0 mm, preferably between 0.5 mm and 2.5 mm,
b) using a mixer and mixing the defibrated straw with a binder material introduced into the mixer in a proportion by weight of between 3% and 25%, preferably between 3% and 10%, more preferably between 3% and 9%, relative to the total weight of the mixture,
c) injecting compressed air into the mixture to homogenise said mixture,
d) depositing the mixture on a conveyor,
e) calibrating the thickness of the mixture to form a continuous mixture strip of a determined thickness,
f) heating the mixture strip to bring it to and/or maintain it at a temperature of at least 90° C., preferably between 110° C. and 150° C., more preferably between 110° C. and 145° C., across the entire thickness of said mixture strip over a heating period dc,
g) cooling the insulation strip thus obtained to an ambient temperature or to a temperature close to the ambient temperature, and calibrating said insulation strip widthwise and lengthwise to form the insulating board, and
h) packaging the insulating board.

According to one embodiment, the method involves, in step a), using at least one grinder to shred and grind the straw in bales, said at least one grinder comprising adjustable shredding/grinding tools for defining the properties of the strands of obtained defibrated straw in terms of shape and size, said tools comprising knives and hammers in sequence.

According to one embodiment, the method involves, in steps b), c) and d), using at least one rotary cylinder-type mixer (3) combined downstream with a chute.

According to one embodiment, the method involves filtering the defibrated straw obtained in a) to remove dust and other impurities in a proportion by weight of at least 2%, preferably at least 5% to 10%, of the defibrated straw.

According to one embodiment, the method involves, in step e), applying a linear pressure to the insulating board being formed, by means of a compression roller. According to another example, it is also possible to use pressure strips or a stainless-steel mould or mesh to calibrate the thickness.

According to one embodiment, the binder material comprises a hot-melt two-component binder selected from two-component binders comprising polylactic biopolymer fibres of the type PLA/Co-PLA, PLA/PBS obtained from cereals.

According to another embodiment, the binder material comprises a hot-melt two-component binder comprising polyester/polyethylene and polyester/PBT fibres.

According to one embodiment, the method involves mixing the binder material, or the mixture of the defibrated straw and the binder material, with one or more additives comprising a fungicidal product in a proportion by weight, relative to the total weight of the mixed products, of between 0.03% and 11%, preferably between 0.5% and 4%.

According to another embodiment, after step f) and preferably after having shaped the mixture lengthwise and widthwise, the method involves spraying, on each face of said mixture, one or more additives comprising a fungicidal product in a proportion by weight, relative to the total weight of the mixed products, of between 0.03% and 11%, preferably between 0.5% and 4%.

By way of example, the additives comprise a fire-retardant product in a proportion by weight, relative to the total weight of the mixed products, of between 24% and 72%. The fire-retardant product is selected, for example, from among products of a family of geo-based products.

By way of example, the fire-retardant product is in viscous or liquid form and comprises a geopolymer of the metakaolin type.

Advantageously, the method comprises an operation for disentangling and aerating the binder material prior to step b).

According to one embodiment, step f) is carried out using a high-frequency or microwave heating system to heat the mixture strip in depth, and also using an additional heating system to heat the mixture strip at its free peripheral edge surfaces, said additional heating system comprising an infrared heating system.

According to another embodiment, the additional heating system may comprise infrared and/or forced-air heating means.

Advantageously, the method involves controlling the advance speed of the conveyor so that the mixture strip passes through an active heating zone for a period corresponding to the minimum heating period de of at least 3 minutes. This minimum heating period dc depends on a set of parameters including the moisture levels in the mixture, the density of the mixture, the thickness of the mixture strip, the type of binder material used, the thermal energy used and/or the duration of exposure to the heat treatment.

According to one embodiment, the method involves using at least one sensor and/or probe to measure the temperature at the edges of the mixture strip and using at least one sensor and/or probe to measure the temperature at the centre of said mixture strip and to continuously control the heating systems depending on values measured by said sensors and/or probes.

According to one embodiment, the method involves using at least one sensor and/or probe to measure the moisture content of the mixture during step d) or e) and to control the heating systems depending on values measured by said sensor and/or probe.

According to one embodiment, the method comprises a step of applying, to at least one face of the insulating board, a fire-retardant or flame-retardant coating which has a thickness of at least 0.5 mm.

The objects of the invention are likewise achieved by means of an insulating board or insulating assembly, which is rigid or semi-rigid and comprises at least one board obtained by the manufacturing method as described above, said board having a density of between 50 kg/m³ and 150 kg/m³, preferably between 60 kg/m³ and 100 kg/m³.

The objects of the invention are likewise achieved by means of a rigid or semi-rigid insulating board comprising a first board obtained by the manufacturing method as described above and on which there is glued an additional fire-retardant board, the additional board also being obtained by the same manufacturing method, having a fire-retardant product in a proportion by weight, relative to the total weight of the mixed products, of more than 49%.

The objects of the invention are likewise achieved by means of a prefabricated modular structure made of wood or a mix of concrete and wood for producing a wall or for internally or externally covering a wall of a building, characterised in that it comprises at least one insulating board manufactured in accordance with the method as described above.

The manufacturing method according to the invention provides the notable advantage that the insulating boards obtained are very homogeneous across their entire thickness. The method according to the invention makes it possible to heat the centre of the insulating boards sufficiently to obtain complete and homogeneous polymerisation across the entire thickness of said insulating boards. This makes it possible to improve their performance in terms of the heat and sound insulation of said board as well as the strength of said boards over time.

Another advantage of the method according to the invention is that the insulating boards obtained have a fire performance classification that renders them suitable to comply with the various standards and regulations in force.

The insulating boards obtained by means of the method according to the invention also exhibit notable performance. These boards have a coefficient of thermal conductivity lambda, λ, of 0.038, which is notable given that the coefficient of thermal conductivity is between 0.052 and 0.080 for straw, between 0.037 and 0.044 for expanded cork and between 0.037 and 0.042 for cellulose wadding.

Owing to the method according to the invention, insulating boards which are much easier to handle and store are obtained. The insulating boards are lighter and smaller compared with straw bales in particular.

Another advantage of the method according to the invention is that it can be carried out at low temperatures and pressures by comparison with those used in the prior art. There is therefore no need to use a stationary press. As a result, the manufacturing method can be carried out more simply and cost-effectively. Furthermore, continuous production can be implemented in a simple manner.

Notably and unexpectedly, the method according to the invention allows the thermal energy supplied to the mixture to be distributed homogeneously in the centre and at the periphery in the context of a continuous fabrication method.

### BRIEF DESCRIPTION OF THE DRAWINGS

Other features and advantages of the present invention will become clearer upon reading the following description, given with reference to the accompanying drawings, which are provided as non-limiting examples only and in which:

FIG. 1 is a schematic view of a flowchart of an embodiment of the manufacturing method according to the invention,

FIG. 2 is a schematic view of a flowchart of another embodiment of the manufacturing method according to the invention,

FIG. 3 is a schematic view of a flowchart of an alternative to the embodiment shown in FIG. 2,

FIG. 4 is a schematic view of a flowchart of an additional embodiment of the manufacturing method according to the invention, and

FIG. 5 is a schematic view of a flowchart of another additional embodiment of the manufacturing method according to the invention.

### DETAILED DESCRIPTION OF THE INVENTION

Structurally and functionally identical elements present in several different figures are denoted by the same alphanumerical or numerical reference.

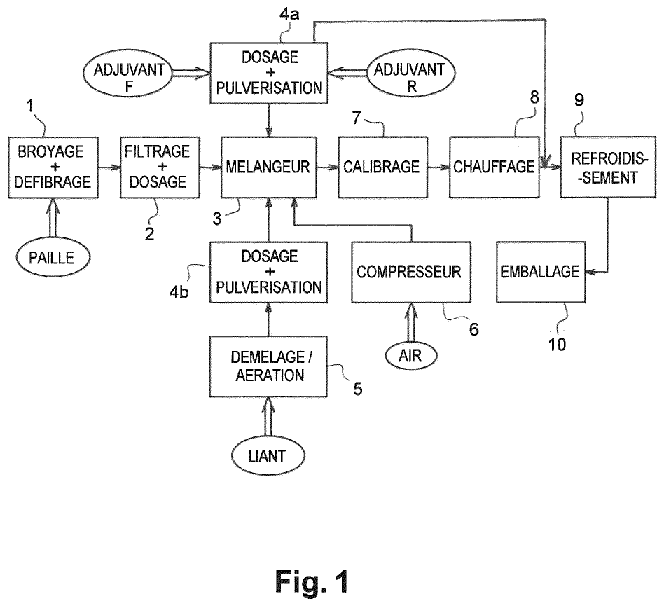

FIG. 1 shows an example installation for carrying out the method for manufacturing insulating boards from cereal straw, such as wheat, barley, oats, rapeseed, miscanthus, rice straw or various mixtures thereof.

The installation comprises a grinding unit 1 for transforming the raw straw into defibrated straw by shredding and grinding.

The grinding and defibrating unit 1 advantageously comprises tools for cutting and breaking the straw strands. By way of example, the grinding and defibrating unit 1 comprises two grinders combined in sequence. The first grinder comprises, for example, tools for cutting the straw strands, such as knives. The second grinder comprises, for example, tools for breaking the straw strands, such as hammers.

The term “defibrated straw” means straw comprising cut and broken strands having an average length of between 3 mm and 22 mm and an average diameter of between 0.5 mm and 4.0 mm. Preferably, the defibrated straw strands have an average length of between 3 mm and 11 mm and an average diameter of between 0.5 mm and 2.5 mm.

The average diameter should be understood as the largest dimension of the straw strand in a plane orthogonal to the longitudinal direction of said strand.

By way of example, defibrated straw comprises 29% to 33% of strands having an average length of 9.633 mm and an average diameter of more than 2 mm, 32% to 37% of strands having an average length of 6.951 mm and an average diameter of more than 1 mm, and 16% to 20% of strands having an average length of 3.960 mm and an average diameter of more than 0.5 mm.

The remainder of this sample is considered to be dust, which is preferably removed by filtration using a filtration/metering unit 2.

By means of a flowchart, FIG. 1 shows an embodiment of a method for manufacturing an insulating board from cereal straw, such as wheat, barley, oats, rapeseed, miscanthus, rice straw or various mixtures thereof.

The installation comprises a grinding and defibrating unit 1 for transforming the raw straw into defibrated straw by shredding and grinding.

The term “defibrated straw” preferably means straw comprising non-homogeneous strands having an average length of between 3 mm and 11 mm and an average diameter of between 0.5 mm and 2.5 mm.

The average diameter should be understood as the largest dimension of the straw strand in a plane orthogonal to the longitudinal direction of said strand.

By way of example, defibrated straw comprises 29% to 33% of strands having an average length of 9.633 mm and an average diameter of more than 2 mm, 32% to 37% of strands having an average length of 6.951 mm and an average diameter of more than 1 mm, and 16% to 20% of strands having an average length of 3.960 mm and an average diameter of more than 0.5 mm.

The remainder of this example sample is considered to be dust, which is preferably removed by filtration using a filtration/metering unit 2.

The manufacturing method is carried out, for example, using an installation shown schematically by the flowchart in FIG. 1.

The installation comprises a grinding/shredding unit 1 fed with straw, for example packaged in bales. The grinding/shredding unit 1 comprises, for example, two grinders in sequence, which may comprise grinding tools having specific shapes or settings.

The grinders advantageously comprise shredding and grinding tools which can be adjusted to define the parameters of the strands of the defibrated straw in terms of shape and size.

According to another embodiment of the installation, the grinding/shredding unit 1 comprises knives for cutting the straw strands and hammers for breaking said strands. As part of the shredding and grinding of the straw, one or more passages may be provided in the grinding/shredding unit 1. The number of passages depends on the desired morphology (shape, length and diameter) of the strands of defibrated straw. At the outlet of the grinding/shredding unit 1, a defibrated straw is thus obtained that is composed of strands optimised in terms of size and shape firstly to promote their mixing with a binder material and secondly to improve the heat and sound insulation properties and mechanical properties of the solid insulating material obtained.

According to one embodiment, the installation also comprises a filtering and metering unit 2 which directly feeds a mixer 3.

The filtering operation is carried out, for example, using, for example, a vibrating screen and/or by means of a cyclonic separator. Said cyclonic separator can advantageously be used to transfer the defibrated straw to the mixer 3. The filtering allows the defibrated straw to be separated from dust and other impurities by gravity or cyclonic filtering.

The mixer 3 comprises, for example, at least one rotary cylinder-type mixer combined downstream with a chute. Advantageously, it is possible to use a plurality of chutes and/or one or more buffer tanks containing the mixture to ensure continuity in the conveyor supply.

The installation also comprises a first metering and spraying unit 4a for supplying the mixer 3 with additives. These additives comprise at least a fungicidal additive F. They may also comprise a fire-retardant additive R.

The installation also comprises a second metering and spraying unit 4b for supplying the mixer 3 with the binder material.

The installation advantageously comprises a disentangling and aeration unit 5 for decompacting the binder material before it is metered and sprayed into the mixer 3. The disentangling and aeration unit 5 comprises, for example, a carding system so as to separate the constituent fibres of the binder material.

The installation also comprises a compressor 6 for injecting compressed air into the mixer 3, thus promoting the homogenisation and aeration of the mixture.

The installation also comprises a unit 7 for shaping and calibrating at least the thickness of the mixture at the outlet of the mixer 3. This shaping and calibration unit 7 makes it possible to produce a mixture strip of a determined shape and thickness, for example by moulding.

The installation also comprises a heating unit 8 for heating the mixture strip across its entire thickness and thus for obtaining the crosslinking of the binder material and consequently the stiffening of the mixture strip or of the preformed insulating board.

The installation also comprises a unit 9 for cooling the mixture strip or the insulating board, at the outlet of the heating unit 8. The cooling unit 9 may consist, by way of example, of a conveyor in the ambient air that takes the insulating board to a packaging unit 10. The cooling unit 9 may also comprise an intermediate storage area, the insulating board being stored for the time required for it to cool.

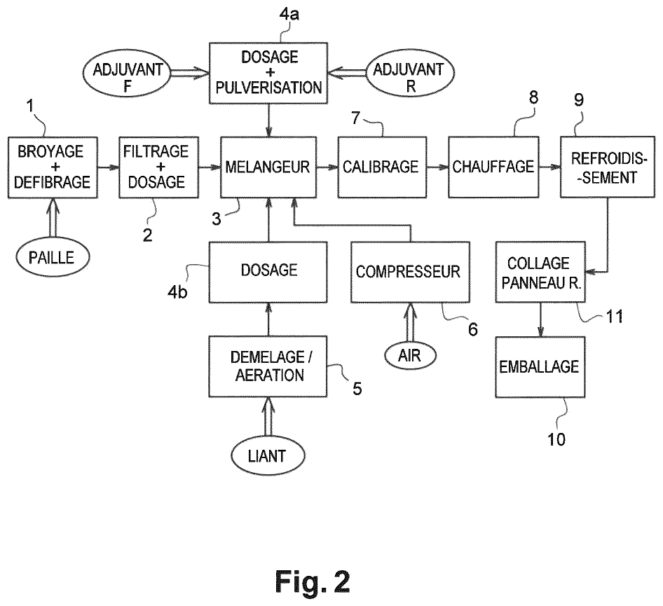

FIG. 2 is a schematic view of a flowchart of another embodiment of the method for manufacturing the insulating board. For this purpose, the installation comprises a gluing unit 11 for gluing an additional rigid fire retardant board onto the rigid or semi-rigid insulating board downstream of the cooling unit 9. This additional board is made, for example, of known materials, for example based on plaster or the like.

According to another embodiment of the method, the additional board is also obtained by the manufacturing method according to the invention. The fire-retardant product then advantageously has a proportion by weight relative to the total weight of the mixed products of more than 49%. This additional board then has a greater density and a smaller thickness than the first rigid or semi-rigid insulating board. An assembly having excellent heat and sound insulation properties as well as good fire performance is thus obtained.

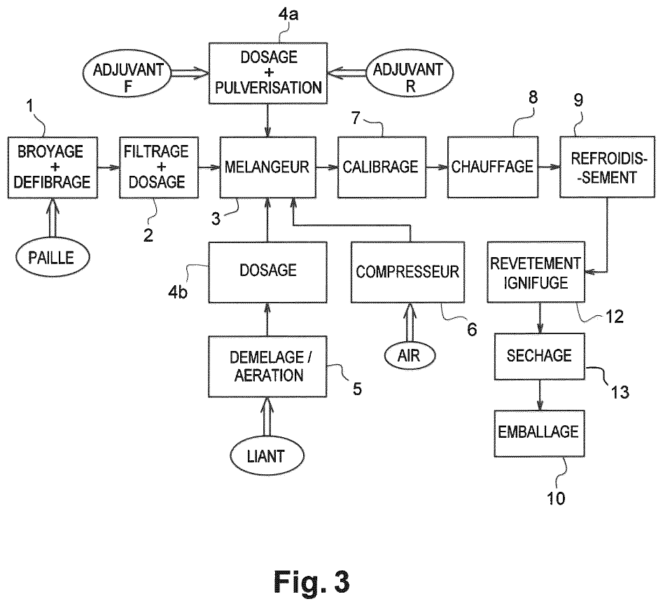

FIG. 3 is a schematic view of a flowchart of another embodiment of the method for manufacturing the insulating board. For this purpose, the installation comprises an application unit 12 for coating the rigid or semi-rigid insulating board with a flame-retardant or fire-retardant coating downstream of the cooling unit 9. This coating is made, for example, of a known fire-retardant product.

The insulating board is then placed in a drying unit 13 before being conveyed to the packaging unit 10.

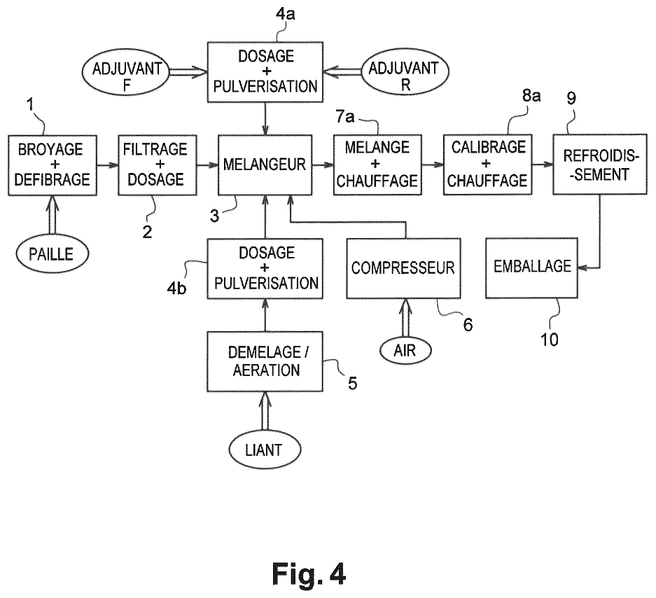

FIG. 4 is a flowchart showing an additional embodiment of the manufacturing method according to the invention. The installation for carrying out the method comprises a heating and complementary mixing unit 7a at the outlet of the mixer 3. By way of example, the heating and complementary mixing unit 7a advantageously comprises a chute into which preheated air is injected.

According to one embodiment, it is possible to use infrared lamps and/or air heated by electrical resistors to heat the mixture in the chute.

Downstream of the chute, the installation comprises a conveyor and a calibration and heating unit 8a, for example in the form of a heating mould, into which the mixture coming from said chute is transferred by gravity or by conveyance.

The heating operation thus continues during and/or after the thickness of the mixture strip is calibrated, before the cooling operation. The mixture continues to be heated in order to maintain temperature for a minimum heating period dc and to achieve optimal crosslinking of the binder material in the mixture.

In step f), according to another embodiment, the calibration and heating unit 8a comprises a system that generates heated air, which is injected under pressure into the insulating board that has been preformed at least in terms of its thickness.

Heating the mixture results in crosslinking of the binder material, which then forms a three-dimensional rigid network in which the strands of defibrated straw and the fibres of the binder material are bonded together.

Since the strands of defibrated straw are cut and broken, they are also mechanically fixed in place in said rigid network of crosslinked binder material.

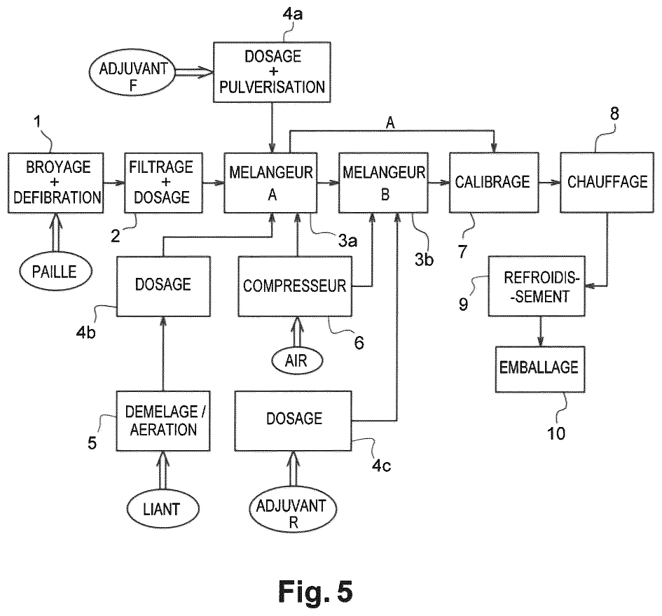

FIG. 5 is a schematic view of a flowchart of another embodiment of the manufacturing method according to the invention. In this embodiment, the installation comprises a first mixer 3a and a second mixer 3b in sequence.

At the outlet of the filtration and metering unit 2, the defibrated straw is conveyed into the first mixer 3a, and the binder material is conveyed into said mixer at the outlet of the second metering and spraying unit 4b.

Depending on the specific features desired for the insulating board, a mixture A prepared in the first mixer 3a, possibly with the addition of a fungicidal additive F, is conveyed to the shaping and calibration unit 7 (arrow A).

Depending on other specific features desired for the insulating board, the mixture A prepared in the first mixer 3a, possibly with the addition of a fungicidal additive F, is conveyed to the second mixer 3b.

A complementary spray metering unit 4c can then inject a fire-retardant additive R into the second mixer 3b. A mixture B is thus obtained, which is conveyed to the shaping and calibration unit 7. The mixture B then leads to the production of an insulating board having more fire-retardant properties depending on the nature and proportion by weight of the fire-retardant additive R used.

The insulating material in board form is therefore manufactured according to one embodiment of the manufacturing method detailed below.

The method for manufacturing the insulating material based on cereal straw comprises a step a) involving grinding, shredding or mechanically cutting the straw to obtain a defibrated straw, the strands of which preferably have an average length of between 3 mm and 11 mm and an average diameter of between 0.5 mm and 2.5 mm.

Advantageously, the method involves filtering the defibrated straw obtained in a) to remove dust and other impurities in a proportion by weight of at least 2%, preferably 5% to 10%, of the defibrated straw. The undesirable residues and dust or other materials affecting the performance of the insulating material can therefore be separated out by gravity using a screen, for example a vibrating screen, or by means of cyclonic filtering. This filtration and separation advantageously makes it possible to reduce the risk of explosion linked to the concentration of dust in the air at the manufacturing sites.

According to a step b), the mixer 3 is used to mix the defibrated straw with a binder material introduced into the mixer 3 (for example by spraying) in a proportion by weight of between 3% and 25%, preferably between 3% and 10%, more preferably between 3% and 9%, relative to the total weight of the mixture.

According to an advantageous embodiment, the method comprises an operation for disentangling and aerating a two-component binder material prior to step b). This preparation of the binder material comprises a carding operation, for example. This disentangling and aeration phase may, for example, be carried out separately or directly in the mixer 3 before the binder material is introduced.

The defibrated straw is then introduced in turn into the mixer 3 or into the first mixer 3a, after the binder material.

According to a step c), compressed air is injected into the mixture, more precisely into the mixer 3, into the first mixer 3a and, where applicable, into the second mixer 3b, in order to homogenise said mixture.

Then, according to a step d), the mixture is deposited, by gravity, onto a conveyor such as a conveyor belt or the like.

According to the subsequent step e), the thickness of the mixture is calibrated to form a continuous strip of a determined thickness. By way of example, a linear pressure is exerted on the mixture strip by means of a compression roller, in order to calibrate the thickness.

Next, according to a step f), the mixture strip is heated to bring it to or maintain it at a temperature of at least 90° C., preferably between 110° C. and 150° C., more preferably between 110° C. and 145° C., across the entire thickness of the mixture strip over a heating period de of at least 3 minutes.

Then, according to a step g), the insulation strip thus obtained is cooled to an ambient temperature or to a temperature close to the ambient temperature. During this step g), the insulating board obtained by cutting the rigid or semi-rigid insulation strip at the periphery is also calibrated widthwise and lengthwise. This operation is carried out in a manner known per se, for example by means of saws.

Lastly, according to a step h), the insulating board is packaged.

According to a preferred example, step f) is carried out using a high-frequency or microwave heating system to heat the mixture strip in depth, and also using an additional heating system to heat the mixture strip at its free peripheral edge surfaces. By way of example, the mixture is heat-treated at least in part by means of a high-frequency heating system. The frequency used is, for example, 13.56 MHz. According to another embodiment, the mixture is heat-treated at least in part by means of a microwave heating system. The frequency used is then, for example, 915 MHz or 2450 MHz.

The additional heating system advantageously comprises an infrared radiation heating system. A plurality of infrared radiation heating systems may be used to irradiate all the peripheral faces, in particular the free peripheral edge surfaces of the mixture strip.

Advantageously, the manufacturing method involves controlling the advance speed of the conveyor so that the mixture strip being transported passes through an active heating zone for a period corresponding to the minimum heating period dc.

Advantageously, the manufacturing method involves using at least one sensor to measure the temperature at the edges of the mixture strip and using at least one sensor to measure the temperature at the centre of said mixture strip. The heating system and the additional heating system are then continuously controlled depending on values measured by said sensors. Maintaining a minimum temperature at the edges of the mixture strip guarantees homogeneous crosslinking of the binder material, even at the edges of said mixture strip.

Advantageously, the manufacturing method involves using at least one sensor to measure the moisture content of the mixture during step d) or e) and to control the heating systems depending on values measured by said sensor. The moisture content of the mixture is advantageously between 5% and 40%, preferably between 12% and 30%, even more preferably between 13% and 25%. By controlling the moisture content and the temperature of the mixture strip at the edges and in the centre, it is possible to significantly reduce the heating energy supplied by the heating systems, since the thermal energy to be dissipated homogeneously in the mixture strip depends on said moisture content.

The duration of the mixing operation(s) depends on the size of the installation and in particular of the mixer 3.

According to one embodiment, the method involves, in step a), using at least one grinder to shred and grind the straw in bales, said at least one grinder comprising shredding/grinding tools which can be adjusted to define the properties of the strands of obtained defibrated straw in terms of shape and size.

Advantageously, the mixers 3, 3a and 3b are rotary cylinders followed downstream by a chute.

According to one embodiment, the binder material comprises a binder comprising hot-melt two-component fibres, polyester/polyethylene or polyester/PBT fibres. Advantageously, these hot-melt two-component fibres have a low melting point of about 110° C.

According to another embodiment, the binder material comprises polylactic biopolymer fibres of the type PLA/Co-PLA, PLA/PBS obtained from cereals. Advantageously, these hot-melt two-component fibres have a low melting point of between 130° C. and 164° C.

According to one embodiment, the method involves mixing the binder material, or the mixture of the defibrated straw and the binder material, with one or more additives comprising a fungicidal product in a proportion by weight, relative to the total weight of the mixed products, of between 0.03% and 11%, preferably between 0.5% and 4%.

According to another embodiment, the method involves, after step f) and preferably after having shaped the mixture lengthwise and widthwise, spraying, on each face of the mixture strip, one or more additives comprising a fungicidal product in a proportion by weight, relative to the total weight of the mixed products, of between 0.03% and 11%, preferably between 0.5% and 4%. Reference can be made, for example, to FIG. 1.

The mixture strip is shaped lengthwise and widthwise by a peripheral cutting operation, for example.

According to another embodiment, the additives comprise a fire-retardant product in a proportion by weight, relative to the total weight of the mixed products, of between 24% and 72%.

According to another embodiment, the fire-retardant product comprises a geopolymer in viscous or liquid form. This may be metakaolin, for example.

According to one embodiment, the method comprises a step of applying, to at least one face of the insulating board, a fire-retardant or flame-retardant coating which has a thickness of at least 0.5 mm.

The invention also relates to a composite insulating board comprising an insulating board obtained according to the manufacturing method set out above and to which an additional fire-retardant board is glued.

The invention also relates to a prefabricated modular structure made of wood for producing a wall or for externally or internally covering a wall of a building. A structure of this kind comprises at least one insulating board obtained according to the manufacturing method set out above.

The invention also relates to a prefabricated modular structure made of a mix of wood and concrete for producing a wall or for externally or internally covering a wall of a building. A structure of this kind comprises at least one insulating board obtained according to the manufacturing method set out above.

By way of example, the method according to the invention makes it possible to manufacture a semi-rigid insulating board having a density of between 50 kg/m³ and 150 kg/m³, preferably between 60 kg/m³ and 100 kg/m³ after cooling. An insulating board having a density of between 50 kg/m³ and 100 kg/m³ has predominantly heat insulation properties, while an insulating board having a density of between 100 kg/m³ and 150 kg/m³ has predominantly fire-resistance and sound insulation properties.

The insulating boards obtained using the method according to the invention can thus have very different technical features. The same manufacturing method can be used to obtain boards suitable for different applications. Depending on said technical features, the board can be applied to a roof, a wall or a floor.

It goes without saying that the present description is not limited to the explicitly described examples but also covers other embodiments and/or implementations. Thus, a described technical feature or method step can be replaced with an equivalent technical feature or step, as applicable, without departing from the scope of the present invention as defined by the claims.

1. A method for continuously manufacturing an insulating board based on cereal straw, said method comprises the steps of:
a) mechanically grinding the straw to obtain a defibrated straw, the strands of which have an average length of between 3 mm and 22 mm, preferably between 3 mm and 11 mm, and an average diameter of between 0.5 mm and 4.0 mm, preferably between 0.5 mm and 2.5 mm,
b) using a mixer (3) and mixing the defibrated straw with a binder material introduced into the mixer (3) in a proportion by weight of between 3% and 25%, preferably between 3% and 10%, more preferably between 3% and 9%, relative to the total weight of the mixture,
c) injecting compressed air into the mixture to homogenise said mixture,
d) depositing the mixture on a conveyor,
e) calibrating the thickness of the mixture to form a continuous mixture strip of a determined thickness,
f) heating the mixture strip to bring it to and/or maintain it at a temperature of at least 90° C., preferably between 110° C. and 150° C., more preferably between 110° C. and 145° C., across the entire thickness of said mixture strip over a heating period dc,
g) cooling the insulation strip thus obtained to an ambient temperature or to a temperature close to the ambient temperature, and calibrating said insulation strip widthwise and lengthwise to form the insulating board,
h) packaging the insulating board.

2. The method according to claim 1, wherein the method involves, in step a), using at least one grinder to shred and grind the straw in bales, said at least one grinder comprising shredding/grinding tools which can be adjusted to define the properties of the strands of obtained defibrated straw in terms of shape and size, said tools comprising knives and hammers in sequence.

3. The method according to claim 1, wherein the method involves, in steps b), c) and d), using at least one rotary cylinder-type mixer combined downstream with a chute from which the conveyor is fed.

4. The method according to claim 1, wherein the method involves filtering the defibrated straw obtained in a) to remove dust and other impurities in a proportion by weight of at least 2%, preferably at least 5% to 10%, of the defibrated straw.

5. The method according to claim 1, wherein the binder material comprises a hot-melt two-component binder selected from two-component binders comprising polylactic biopolymer fibres of the type PLA/Co-PLA, PLA/PBS obtained from cereals.

6. The method according to claim 1, wherein the binder material comprises a hot-melt two-component binder comprising polyester/polyethylene or polyester/PBT fibres.

7. The method according to claim 1, wherein said method involves mixing the binder material, or the mixture of the defibrated straw and the binder material, with one or more additives comprising a fungicidal product in a proportion by weight, relative to the total weight of the mixed products, of between 0.03% and 11%, preferably between 0.5% and 4%.

8. The method according to claim 1, wherein the method involves, after step f) and preferably after having shaped the mixture lengthwise and widthwise, spraying, on each face of said mixture, one or more additives comprising a fungicidal product in a proportion by weight, relative to the total weight of the mixed products, of between 0.03% and 11%, preferably between 0.5% and 4%.

9. The method according to claim 1, wherein the additives comprise a fire-retardant product in a proportion by weight, relative to the total weight of the mixed products, of between 24% and 72%.

10. The method according to claim 5, wherein said method comprises an operation for disentangling and aerating the binder material prior to step b).

11. The method according to claim 1, wherein step f) is carried out using a high-frequency or microwave heating system to heat the mixture strip in depth, and also using an additional heating system to heat the mixture strip at its free peripheral edge surfaces, said additional heating system comprising an infrared heating system.

12. The method according to any of claim 1, wherein said method involves using at least one sensor and/or probe to measure the temperature at the edges of the mixture strip and using at least one sensor and/or probe to measure the temperature at the centre of said mixture strip and to continuously control the heating systems depending on values measured by said sensors and/or probes.

13. The method according to claim 1, wherein said method involves using at least one sensor and/or probe to measure the moisture content of the mixture during step d) or e) and to control the heating systems depending on values measured by said sensor and/or probe.

14. An insulating board or insulating assembly, which is semi-rigid and comprises at least one board obtained by the manufacturing method according to claim 1, said board having a density of between 50 kg/m³ and 150 kg/m³, preferably between 60 kg/m³ and 100 kg/m³.

15. A prefabricated modular structure made of wood or a mix of concrete and wood for producing a wall or for externally or internally covering a wall of a building, wherein said prefabricated modular structure comprises at least one insulating board manufactured in accordance with the method according to claim 1.
